(19) United States
(12) Patent Application Publication
(10) Pub. No.: US 2002/0056595 A1
(43) Pub. Date: May 16, 2002

(54) Braking structure of scooter

(76) Inventor: Anthony Shaw, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/730,806

(22) Filed: Dec. 7, 2000

(30) Foreign Application Priority Data
Nov. 10, 2000 (TW) 89219514

(51) Int. Cl. B60T 1/14

(52) U.S. Cl. 188/5; 188/29

(57) ABSTRACT

A scooter has a braking structure comprising a support frame, an application portion, and two brake shoes. The support frame has two support arms which are located at two sides of the rear wheel of the scooter. The brake shoes are fastened with the support arms. As the application portion is exerted on by an external force, the support frame is forced to move downward, thereby causing the brake shoes to come in contact with the rear wheel.

### FIELD OF THE INVENTION

The present invention relates generally to a scooter, and more particularly to a braking structure of the scooter.

### BACKGROUND OF THE INVENTION

As shown in FIG. 1, a scooter braking structure of the prior art has an urging member 4, which is used to keep the inner side 3a of a wheel cover 3 apart from a rear wheel 2 fastened to the rear end of a scooter footboard 1. As the rear wheel cover 3 is exerted on by an external force, the inner side 3a of the rear wheel cover 3 comes in contact with the rear wheel 2, thereby resulting in a braking effect on the rear wheel 2 in motion.

Such a prior art scooter braking structure as described above is defective in design in that the wheel cover 3 is apt to move aside at the time when it is exerted on by the external force, thereby undermining the braking effect of the wheel cover 3. In addition, the wheel cover 3 is incapable of exerting a uniform braking effect on the rear wheel 2. Furthermore, the braking effect of the wheel cover 3 on the rear wheel 2 is poor at best in view of the fact that the friction area between the inner side 3a of the rear wheel cover 3 and the rear wheel 2 is small.

### SUMMARY OF THE INVENTION

The primary objective of the present invention is to provide a scooter with a braking structure which is free of the deficiencies of the prior art scooter braking structure described above.

The braking structure of the present invention is mounted at the rear end of a scooter footboard and is formed of a support frame, an application portion, and two brake shoes. The support frame has two support arms, which are mounted at two sides of a scooter rear wheel. The brake shoes are respectively fastened with the two support arms. As the application portion is exerted on by an external force, the support frame is actuated such that the brake shoes are forced against the rear wheel in motion.

### BRIEF DESCRIPTION OF THE DRAWINGS

FIG. 1 shows a schematic view of a scooter braking structure of the prior art.

FIG. 2 shows a schematic view of a first preferred embodiment of the present invention.

FIG. 3 shows a side view of the first preferred embodiment of the present invention.

FIG. 4 shows a perspective view of the first preferred embodiment of the present invention.

FIG. 5 shows a schematic view of a second preferred embodiment of the present invention.

FIG. 6 shows a schematic view of a third preferred embodiment of the present invention.

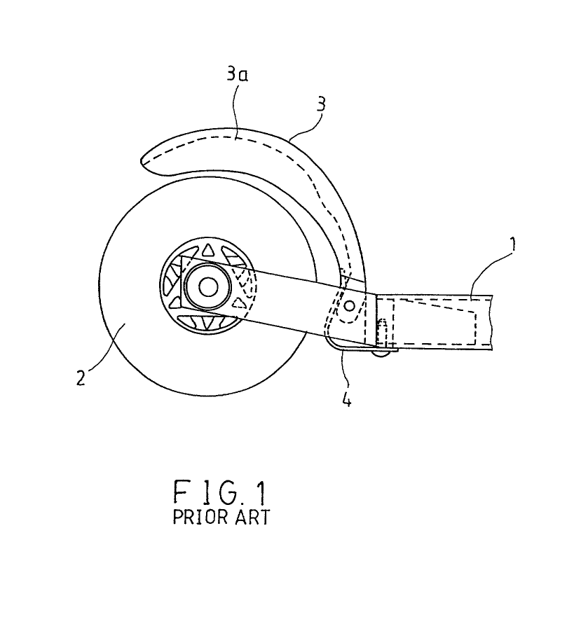

### DETAILED DESCRIPTION OF THE INVENTION

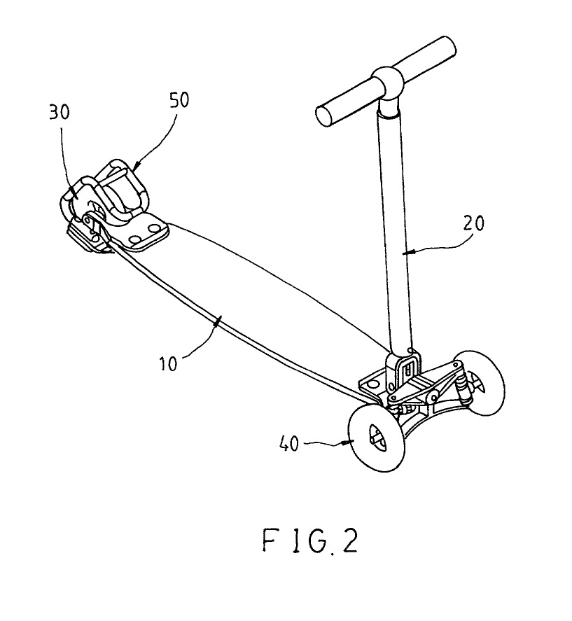

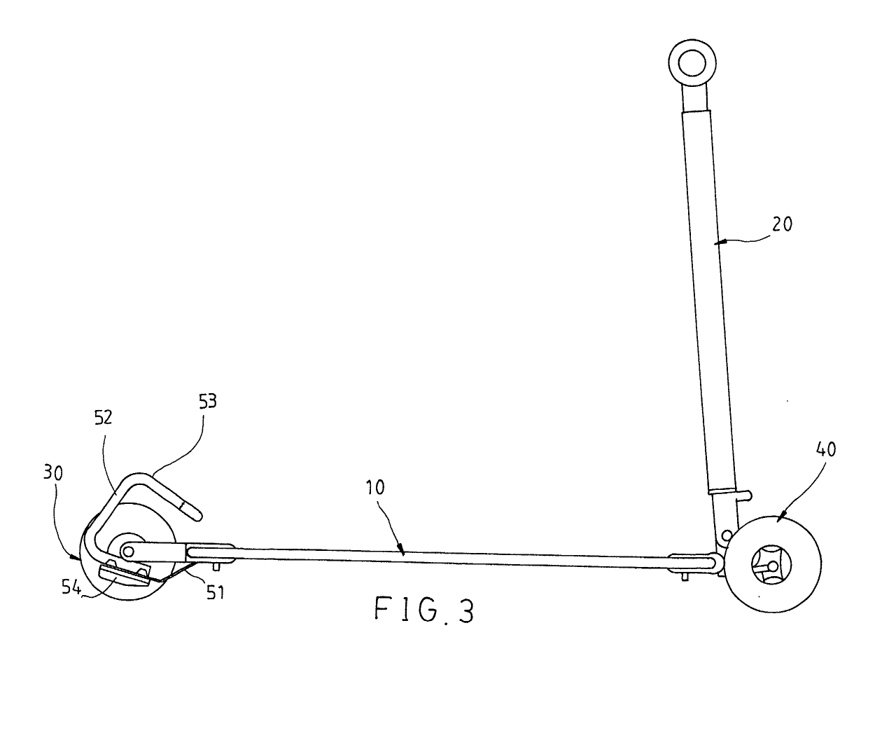

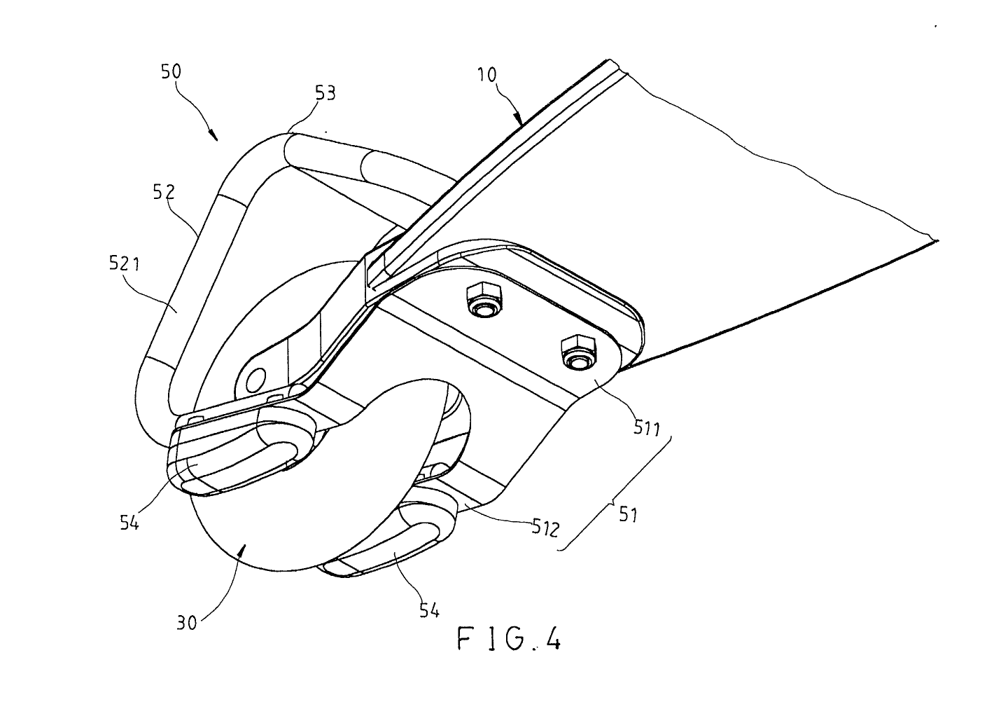

As shown in FIGS. 2-4, a scooter embodied in the present invention comprises a footboard 10, a handlebar frame 20, a rear wheel 30, a front wheel 40, and a braking structure 50 which is mounted at the rear end of the footboard 10 and is formed of a connection member 51, a support frame 52, an application portion 53, and two brake shoes 54.

The connection member 51 is formed of a plate 511, which is fastened with the underside of the footboard 10 and is provided with two elastic connection pieces 512 extending from the plate 511.

The support frame 52 and the application portion 53 are integrally made such that the application portion 53 is formed by two support arms 521 of the support frame 52. The two support arms 521 are fastened at one end with the connection pieces 512 of the connection member 51 such that the two support arms 521 are located at two sides of the rear wheel 30.

The brake shoes 54 are fastened with the underside of the connection pieces 512 of the connection member 51. As the support frame 52 is exerted on by an external force, the brake shoes 54 are forced against the rear wheel 30 in motion, so as to slow down or stop the scooter in motion. The braking effect of the brake shoes 54 on the rear wheel 30 is precise and even, without causing the rear wheel 30 to swivel aside.

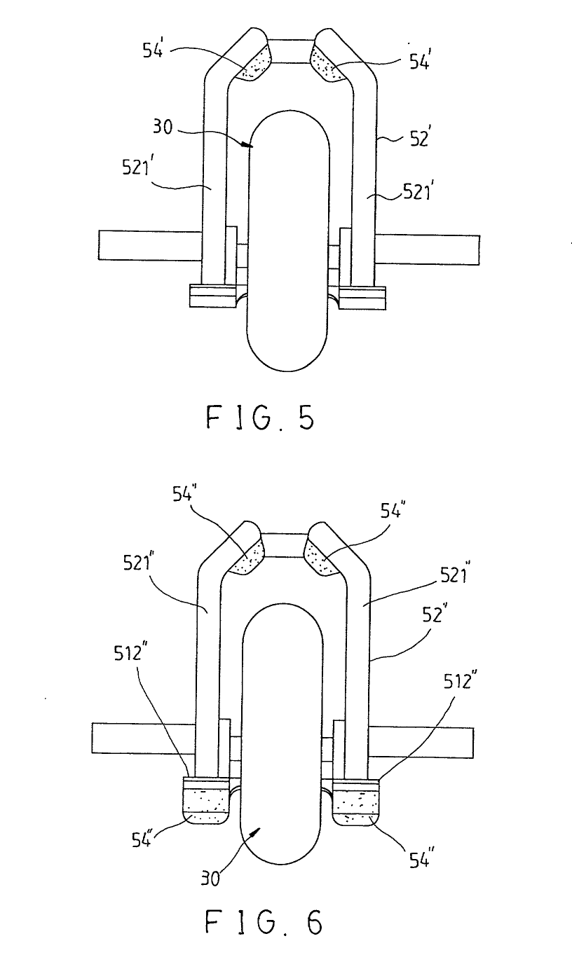

As shown in FIG. 5, two brake shoes 54′ of the second preferred embodiment of the present invention are fastened with inner sides of the two support arms 521′. As the support frame 52′ is forced to move downward, the two brake shoes 54′ come in contact with the rear wheel 30 in motion, thereby resulting in an even and precise braking effect on the rear wheel 30.

As shown in FIG. 6, the third preferred embodiment of the present invention has four brake shoes 54″, which are respectively fastened with the underside of each connection piece 512″ and the inner side of each support arm 521″. As the support frame 52″ is forced to move downward by an external force, the brake shoes 54″ come in contact with the rear wheel 30 in motion, as well as the ground surface on which the scooter cruises.

The embodiments of the present invention described above are to be regarded in all respects as being merely illustrative and not restrictive. Accordingly, the present invention may be embodied in other specific forms without deviating from the spirit thereof. The present invention is therefore to be limited only by the scopes of the following appended claims.

What is claimed is:

1. A braking structure of a scooter, said braking structure comprising:
a support frame having two support arms extending from the rear end of a footboard of the scooter such that said two support arms are located at two sides of a rear wheel of the scooter;
an application portion for forcing said support frame to move downward at such time when said application portion is exerted on by an external force; and
at least two brake shoes fastened with said two support arms such that said brake shoes stop or slow down the scooter in motion.

2. The braking structure as defined in claim 1, wherein said brake shoes are fastened with the undersides of said support arms whereby said brake shoes come in contact with a ground surface at the time when said support frame is forced to move downward.

3. The braking structure as defined in claim 1, wherein said brake shoes are fastened with the inner sides of said support arms whereby said brake shoes come in contact with the rear wheel of the scooter at the time when said support frame is forced to move downward.

4. The braking structure as defined in claim 1, wherein said support frame is provided with four brake shoes, with two of said four brake shoes being fastened with the undersides of said two support arms, and with other two of said four brake shoes being fastened with the inner sides of said two support arms whereby said two brake shoes come in contact with a ground surface and said other two brake shoes come in contact with the rear wheel of the scooter at the time when said support frame is forced to move downward.

5. The braking structure as defined in claim 1, wherein said support frame and said application portion are made integrally.

6. The braking structure as defined in claim 1, wherein said support frame is fastened with the underside of the footboard of the scooter by a connection member.
